(19) United States
(12) Patent Application Publication
(10) Pub. No.: US 2018/0322196 A1
(43) Pub. Date: Nov. 8, 2018

(54) SYSTEM AND METHOD FOR SHARING PRESET COLLECTIONS

(71) Applicant: BOSE CORPORATION, Framingham, MA (US)

(72) Inventor: Gregg Michael Duthaler, Needham, MA (US)

(21) Appl. No.: 15/586,561

(22) Filed: May 4, 2017

(51) Int. Cl. G06F 17/30; G06Q 50/00

(52) U.S. Cl. CPC G06F 17/30772; G06Q 50/01; G06F 17/30766

(57) ABSTRACT

A method comprises receiving, at a computer system of a retailer, a definition of a preset collection including a plurality of presets for a streaming music player from a first user, sending a second user an indication of the preset collection, receiving, at the computer system of the retailer, a selection by the second user of the preset collection, and sending instructions to assign the plurality of presets to preset indicators of a streaming music player of the second user.

### TECHNICAL FIELD

Aspects and implementations of the present disclosure are directed generally to streaming media player devices and specifically to systems and methods for sharing collections of preset channels of same.

### BACKGROUND

Streaming media players, for example streaming music players, allow a user to access and stream content from external sources, including internet radio stations or other streaming media service providers. Some streaming music players include functionality for storing preset or favorite channels or stations such that a user may access a favorite channel or station by, for example, actuating an button or other feature associated with the favorite channel on the streaming music player or on a controller for the streaming music player. The user sets the preset channels or stations after the streaming music player has been purchased and set up.

### SUMMARY

In accordance with an aspect of the present disclosure, there is provided a computer system comprising a processor and a non-transitory computer readable memory including instructions that when executed by the processor cause the computer system to receive a definition of a preset collection including a plurality of presets for a streaming music player from a first user, present a second user with an indication of the preset collection, receive an indication of a selection by the second user of the preset collection, and send instructions to assign the plurality of presets to preset indicators of a streaming music player of the second user responsive to the indication of the selection received from the second user.

In some implementations, the instructions, when executed by the processor, further cause the computer system to notify the first user of a refusal of acceptance of the preset collection from the second user responsive to receiving an indication of refusal of acceptance of the preset collection from the second user.

In some implementations, the instructions, when executed by the processor, further cause the computer system to execute software configured to control or otherwise interact with a device other than the streaming music player of the second user or a controller of the streaming music player of the second user, and associate the software with one of the preset indicators of the streaming music player of the second user, selection of the one of the preset indicators causing the software to be executed by the one of the streaming music player of the second user, the controller of the streaming music player of the second user, or other device.

In some implementations, the software, when executed by the one of the streaming music player of the second user or the controller of the streaming music player causes one or more of audio rendered through the streaming music player of the second user to be synchronized with a video presentation of a video display device of the second user or lighting in a home of the second user to be adjusted.

In some implementations, the instructions, when executed by the processor, further cause the computer system to present a search tool configured to search for a preset collection in a memory of the computer system to a user, receive a search query from the user in the search tool, and present a list of one or more preset collections matching the search criteria to the user.

In some implementations, the instructions, when executed by the processor, further cause the computer system to send an indication of the preset collection to one or more of the second user's streaming music player, a controller of the second user's streaming music player, or an online account associated with the second user's streaming music player.

In some implementations, the instructions, when executed by the processor, further cause the computer system to present a plurality of users with the indication of the preset collection, receive indications of selections of the preset collection by the plurality of users, and send instructions to assign the plurality of presets to preset indicators of streaming music players or controllers of said music players of the plurality of users responsive to the receipt of the indications of the selections from the plurality of users.

In some implementations, the instructions, when executed by the processor, further cause the computer system to increase a popularity ranking of the first user responsive to receiving an indication of a selection of the preset collection by one of the plurality of users.

In some implementations, the instructions, when executed by the processor, further cause the computer system to present the plurality of users with the indication of the preset collection responsive to the first user defining the preset collection in the system.

In some implementations, the instructions, when executed by the processor, further cause the computer system to present the first user with a list of streaming audio channels to select from to include as presets in the preset collection by identifying a source of streaming audio channels, and presenting a list of streaming audio channels in a composite web page having a look and feel of a host web page of a retailer associated with the streaming music player.

In some implementations, the instructions, when executed by the processor, further cause the computer system to associate a user ID of the first user with the preset collection.

In accordance with another aspect of the present disclosure, there is provided a method comprising receiving, at a computer system, a definition of a preset collection including a plurality of presets for a streaming music player from a first user, sending a second user an indication of the preset collection, receiving, at the computer system, an indication of a selection by the second user of the preset collection, and sending instructions to assign the plurality of presets to preset indicators of a streaming music player of the second user responsive to receiving the indication of the selection.

In some implementations, the method further comprises receiving, at the computer system, an indication of a refusal of acceptance of the preset collection from the second user, and notifying the first user of the refusal of acceptance.

In some implementations, the method further comprises sending instructions configured to control a device other than the streaming music player of the second user to one of the streaming music player of the second user or a controller of the streaming music player of the second user, associating the instructions with one of the preset indicators of the streaming music player of the second user, and executing the instructions by the one of the streaming music player of the second user or the controller of the streaming music player of the second user responsive to selection of the one of the preset indicators.

In some implementations, the method further comprises presenting a search tool configured to search for a preset collection in a memory of the computer system to a user, receiving a search query from the user in the search tool, and presenting a list of one or more preset collections matching the search criteria to the user.

In some implementations, the method further comprises downloading the definition of the preset collection to one or more of the second user's streaming music player, a controller of the second user's streaming music player, or an online account associated with the second user's streaming music player.

In some implementations, the method further comprises presenting a plurality of users with an indication of the preset collection, receiving indications of selections of the preset collection by the plurality of users, and assigning the plurality of presets to preset indicators of streaming music players of the plurality of users responsive to receiving the indications of the selections from the plurality of users.

In some implementations, the method further comprises increasing a popularity ranking of the first user responsive to receiving an indication of a selection of the preset collection by one of the plurality of users.

In some implementations, the method further comprises presenting the plurality of users with the indication of the preset collection responsive to the first user defining the preset collection in the system.

In accordance with another aspect of the present disclosure, there is provided a streaming music player comprising a processor, a network interface operatively coupled to the processor and configured to access streaming audio content from one or more streaming audio content sources, an electro-acoustic transducer operatively coupled to the processor, a plurality of preset indicators operatively coupled to the processor, each of the plurality of preset indicators configured to initiate streaming and rendering of content from an assigned audio channel from one of the streaming audio content sources through the electro-acoustic transducer, and a memory operatively coupled to the processor, the memory including programming which when executed by the processor causes the processor to access a cloud-based database including account information associated with the streaming music player including a set of collections of audio channel presets associated with a unique identifier of the streaming music player and to assign one of the collections of audio channel presets to the plurality of preset indicators.

In some implementations, the streaming music player is configured to execute instructions that control operation of a device other than the streaming music player responsive to selection of a preset indicator associated with the instructions.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1A is a perspective view of an exemplary streaming music player;

FIG. 1B is a top plan view of the streaming music player of FIG. 1A;

FIG. 1C is a block diagram of the streaming music player of FIG. 1A;

FIG. 1D illustrates a controller for the streaming music player of FIG. 1A;

FIG. 2 is a flow chart of a method for a user to send another user a collection of presets;

FIG. 3 is a flow chart of a method for a user to send a plurality of other users a collection of presets; and

FIG. 4 illustrates a computer system upon which aspects of methods disclosed herein may be performed.

### DETAILED DESCRIPTION

Aspects and implementations disclosed herein are not limited to the details of construction and the arrangement of components set forth in the following description or illustrated in the drawings. Aspects and implementations disclosed herein are capable of being practiced or of being carried out in various ways.

Aspects and implementations disclosed herein are generally directed to systems and methods for a first user to create and share preset “collections” by combining a set of preset stations or channels to be assigned to the presets of a streaming music player. The first user may then share the created collection(s) with one or more other users. The one or more other users may assign the preset stations or channels in the shared collection(s) to the presets of their streaming music player. The terms “stations” and “channels” are used interchangeably herein and encompass internet radio channels, playlists from streaming services, concatenations of content from one or more streaming services, or other pre-defined locations or access points for accessing streaming music. Although referred to herein as a “streaming music player,” it is to be understood that the disclosed streaming music player may be utilized to stream audio content other than music.

A “preset collection,” as used herein, refers to a set of preset assignments. Each “preset assignment” (a/k/a “preset”) is an assignment of an entity associated with one of a plurality of digital audio sources to one of a plurality of preset indicators on a streaming music player.

The systems and methods disclosed herein may extend the functionality of streaming music player presets, may encourage users to explore new or different subscription music services, and may encourage social interaction among members of a community of users. The systems and methods disclosed herein may further advance “collections” as a new “currency” in the digital music space.

In some implementations, preset collections may not only include sets of preset stations or channels, but may also include macros that may interact with “internet of things” enabled devices in a user's home. For example, a preset collection may include software that synchronizes music in a particular playlist or channel with a digital slide show presented on a user's television or computer. In other examples, a preset collection may include software that adjusts lighting in a user's home based on a selected playlist or channel For example, if a user selects a preset assigned to a playlist or channel featuring romantic music, the steaming music player may interact with the lighting system in the user's home to dim the lights.

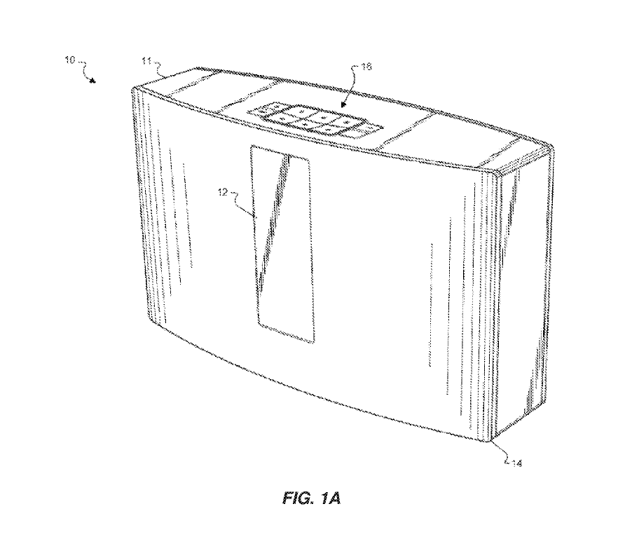

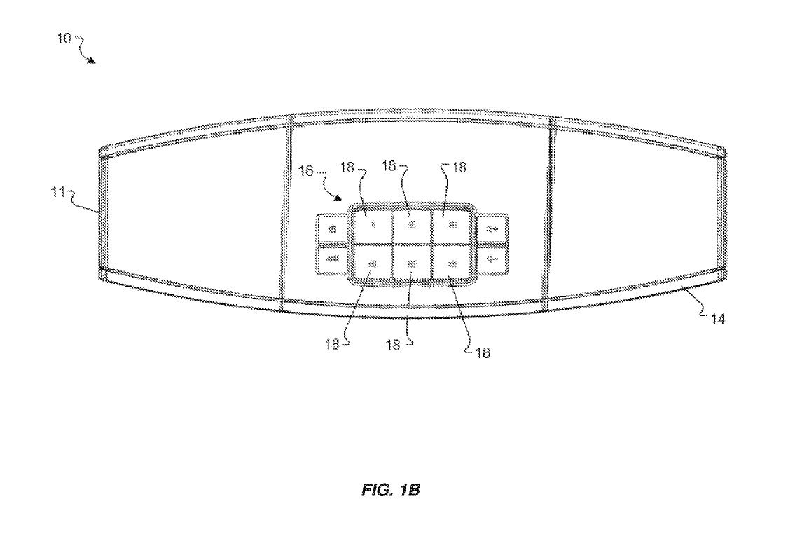

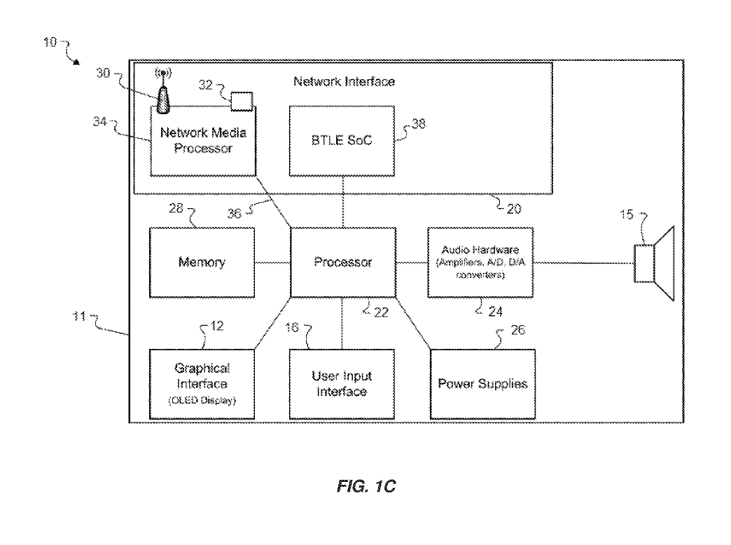

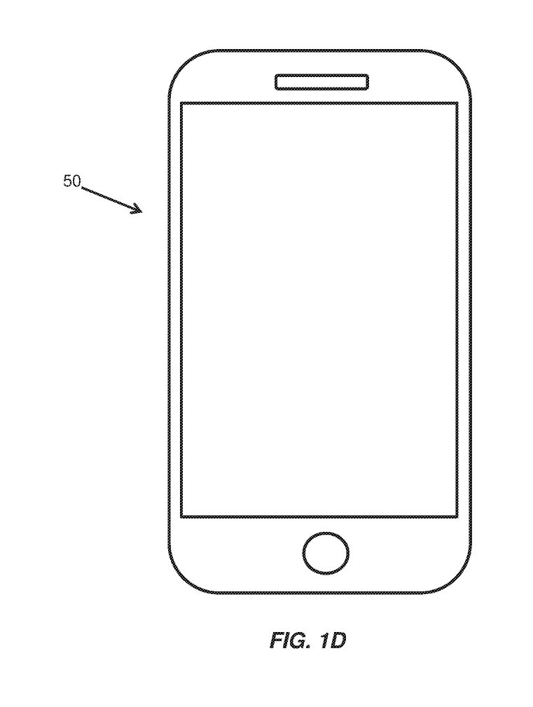

The aspects and implementations disclosed herein are generally applicable to any one of multiple streaming music players. In one implementation, the streaming music player is one of the SoundTouch® audio playback devices available from the Bose Corporation. An example of such a system is illustrated in FIGS. 1A-1C. This device is described in co-owned U.S. Pat. No. 9,330,169 “AUDIO SYSTEMS AND RELATED DEVICES AND METHODS,” which is incorporated herein by reference in its entirety for all purposes.

Referring to FIG. 1A, the audio playback device 10 includes an enclosure 11 and on the enclosure 11 there resides a graphical interface 12 (e.g., an OLED display) which can provide a user with information regarding currently playing (“Now Playing”) music and information regarding the presets. A screen 14 conceals one or more electro-acoustic transducers 15 (FIG. 1C). The audio playback device 10 also includes a user input interface 16. As shown in FIG. 1B, the user input interface 16 includes a plurality of preset indicators 18, which are hardware buttons in the illustrated example. The preset indicators 18 (numbered 1-6) provide the user with easy, one press access to entities assigned to those buttons. That is, a single press of a selected one of the preset indicators 18 will initiate streaming and rendering of content from the assigned entity.

The assigned entities can be associated with different digital audio sources, for example, stations, channels, or playlists from internet radio stations or streaming music services such as the Pandora®, Spotify®, vTuner®, iHeartRadio®, Deezer®, SiriusXM®, Amazon Music, etc. services. A single audio playback device 10 can provide for single press access to various different digital audio sources. In one example, the assigned entities include (i) user-defined playlists of digital music, (ii) Internet radio stations, and/or (iii) radio stations. In another example, the digital audio sources include a plurality of Internet radio sites, and the assigned entities include individual radio stations provided by those Internet radio sites.

Notably, the preset indicators 18 operate in the same manner, at least from the user's perspective, regardless of which entities are assigned and which of the digital audio sources provide the assigned entities. That is, each preset indicator 18 can provide for single press access to its assigned entity whether that entity is a user-defined playlist of digital music provided by a network attached storage (NAS) device or an Internet radio station provided by an Internet music service.

With reference to FIG. 1C, the audio playback device 10 also includes a network interface 20, a processor 22, audio hardware 24, power supplies 26 for powering the various audio playback device components, and memory 28. Each of the processor 22, the graphical interface 12, the network interface 20, the audio hardware 24, the power supplies 26, and the memory 28 are interconnected using various buses, and several of the components may be mounted on a common motherboard or in other manners as appropriate.

The network interface 20 provides for communication between the audio playback device 10 and a controller (for example, a remote control or a smart phone or computer having an appropriate control application installed), a server connected to the internet or cloud-based server that may contain an account database including information regarding an audio system account of a user, audio sources, and other audio playback devices 10 via one or more communications protocols. The network interface 20 may provide either or both of a wireless interface 30 and a wired interface 32. The wireless interface 30 allows the audio playback device 10 to communicate wirelessly with other devices in accordance with a communication protocol such as such as IEEE 802.11b/g. The wired interface 32 provides network interface functions via a wired (e.g., Ethernet) connection.

In some examples, the network interface 20 may also include a network media processor 34 for supporting Apple AirPlay® (a proprietary protocol stack/suite developed by Apple Inc., with headquarters in Cupertino, Calif., that allows wireless streaming of audio, video, and photos, together with related metadata between devices). For example, if a user connects an AirPlay® enabled device, such as an iPhone or iPad device, to a LAN which the audio playback device 10 is in communication with, the user can then stream music to the network connected audio playback devices 10 via Apple AirPlay®. A suitable network media processor is the DM870 processor available from SMSC of Hauppauge, N.Y. The network media processor 34 provides network access (e.g., the Wi-Fi network and/or Ethernet connection can be provided through the network media processor 34) and AirPlay® audio. AirPlay® audio signals are passed to the processor 22, using the I2S protocol (an electrical serial bus interface standard used for connecting digital audio devices), for downstream processing and playback. Notably, the audio playback device 10 can support audio-streaming via AirPlay® and/or DLNA's UPnP protocols, and all integrated within one device.

All other digital audio coming from network packets comes straight from the network media processor 34 through a USB bridge 36 to the processor 22 and runs into the decoders, DSP, and eventually is played back (rendered) via the electro-acoustic transducer(s) 15. The network interface 11 can also include a Bluetooth low energy (BTLE) system-on-chip (SoC) 738 for Bluetooth low energy applications (e.g., for wireless communication with a Bluetooth enabled controller. A suitable BTLE SoC is the CC2540 available from Texas Instruments, with headquarters in Dallas, Tex.

Streamed data pass from the network interface 20 to the processor 22. The processor 22 can execute instructions within the audio playback device (e.g., for performing, among other things, digital signal processing, decoding, and equalization functions), including instructions stored in the memory 28. The processor 22 may be implemented as a chipset of chips that include separate and multiple analog and digital processors. The processor 22 may provide, for example, for coordination of other components of the audio playback device 10, such as control of user interfaces, or applications run by the audio playback device 10. A suitable processor is the DA921 available from Texas Instruments.

The processor 22 provides a processed digital audio signal to the audio hardware 24 which includes one or more digital-to-analog (D/A) converters for converting the digital audio signal to an analog audio signal. The audio hardware 24 also includes one or more amplifiers which provide amplified analog audio signals to the electroacoustic transducer(s) 15 for playback. In addition, the audio hardware 24 may include circuitry for processing analog input signals to provide digital audio signals for sharing with other devices.

The memory 28 stores information within the audio playback device 10. In this regard, the memory 28 may store account information, such as information regarding the audio station or channel presets. The memory 28 may also provide storage for “tokens” for facilitating single press access to the digital audio sources, for example, internet radio services. A token, as used herein, is a unique identifier that may be provided by a digital audio source and which allows the digital audio source to recognize the audio playback device 10 as being associated with a user's account with the digital audio source and without requiring the user to enter credentials (e.g., user name, password, etc.) each time the audio playback device 10 attempts to access the digital audio source.

The memory 28 may include, for example, flash memory and/or non-volatile random access memory (NVRAM). In some implementations, instructions (e.g., software) are stored in an information carrier. The instructions, when executed by one or more processing devices (e.g., the processor 22), perform one or more processes, such as those described below for accessing preset collections and/or assigning the stations, channels, or playlists in an accessed preset collection to the preset indicators 18 of the streaming music player. The instructions can also be stored by one or more storage devices, such as one or more computer- or machine-readable mediums (for example, the memory 28, or memory on the processor). The instructions may include instructions for performing decoding (i.e., the software modules include the audio codecs for decoding the digital audio streams), as well as digital signal processing and equalization. In accordance with some aspects and implementations, the memory 28 includes instructions, that when executed by the processor causes the processor to access a cloud-based database including account information associated with the audio playback device 10 or user, including a set of user-defined audio channel presets or one or more preset collections and to assign the user-defined audio channel presets or the stations, channels, or playlists in a selected one of the one or more preset collections to the plurality of preset indicators 18.

A user may operate the streaming music player by interacting directly with the user input interface 16. Alternatively, a user may operate the streaming music player using an app installed on a streaming music player controller, for example, a smart phone 50 (FIG. 1D) or other mobile device.

In some implementations, users of streaming music players may store multiple collections in their user accounts and/or in a controller of their streaming music player that can be recalled at will to select between different sets of preset assignments. Each user account may have a bank of preset collections associated with it, thereby allowing the number of available preset assignments to exceed the number of physical preset buttons on the streaming music player and without having to permanently delete existing preset assignments to add more.

The preset collections may be shareable between users either by peer-to-peer sharing or peer-to-many sharing. In the peer-to-peer sharing approach, a first user can create a new preset collection and then make it available to a second user. For example, the first user can elect to send the shared preset collection to the second user via an application on a mobile device, for example, a smartphone or other form of controller for the streaming music player of the first user. The second user will receive a notification via an app running on their mobile device or other form of controller for their streaming music player and will be prompted to accept (or ignore or decline) the shared preset collection. If accepted, the shared preset collection will be added to the second user's set of preset collections which will be stored on her mobile device or controller and/or in the cloud storage associated with the second user's account. Once added to the second user's account, the second user can swap out an existing set of preset assignments for the shared collection. If at some time in the future the second user wants to revert back to the original set of preset assignments, they can simply recall the corresponding collection from device memory and/or associated cloud-based storage.

The sharing of preset collections in this manner can be used to promote the on-boarding of users to new music services. For example, if one or more of the preset assignments in the shared collection is associated with a music service which the second user does not have an account with, the second user may be prompted to create/open such an account before the shared preset collection can be accessed and/or utilized. In some implementations, the second user's election to accept the shared preset collection may direct the second user to an account setup page for a related music service. This can encourage users to expand the number of music services that they use. In some implementations, trial memberships may be offered to allow temporary use of preset assignments associated with subscription music services which the user does not currently subscribe to.

In the peer-to-many approach, preset collections could be shared (e.g., pushed) from a first user, acting effectively as a disk jockey (DJ) to many listeners/subscribers. For example, the first user may create a new preset collection and push it out to his followers/fans, which may number in the hundreds, thousands, millions, or more. Each of the individual followers will receive a notification that a new shared collection is available and will be prompted to accept or ignore/decline it. Under the peer-to-many approach, the sharing of preset collections can be monetized. For example, access to preset collections may be established on a subscription basis, where, for a subscription fee, users can view, access and/or use preset collections that others (DJs) have created. Alternatively or additionally, users may be required to pay a per-collection fee (e.g., S1 per download, or a monthly or yearly fee for a certain number, or even unlimited, collection downloads) to access a shared preset collection. The access can be time limited. Those skilled in modern music service subscription models will see still further permutations on these approaches. In still other related implementations, a preset collection might be used to capture special moments or for a limited time advertising promotion (e.g. a birthday collection as a peer-to-peer gift or a one-to-many release of teaser content for a forthcoming concert).

Alternatively or additionally, the sharing of preset collections under the peer-to-many approach could be gamified to help accelerate adoption of the collections concept. In that regard, as more and more followers “like” a user's presets that user will move up in status. A form of tiering can be set up for users (DJs) that make the most popular collections. Popular users/DJs could effectively bubble up through a collections app store where they move up in ranking because their preset collections have done a better job of appealing to the user/subscriber community. The peer-to-many approach allows the notion of being a DJ to be democratized.

As in the peer-to-peer approach, any users that are not also subscribers to the music services implicated in the shared preset collection will be prompted to create a new music service account to utilize the shared preset collection.

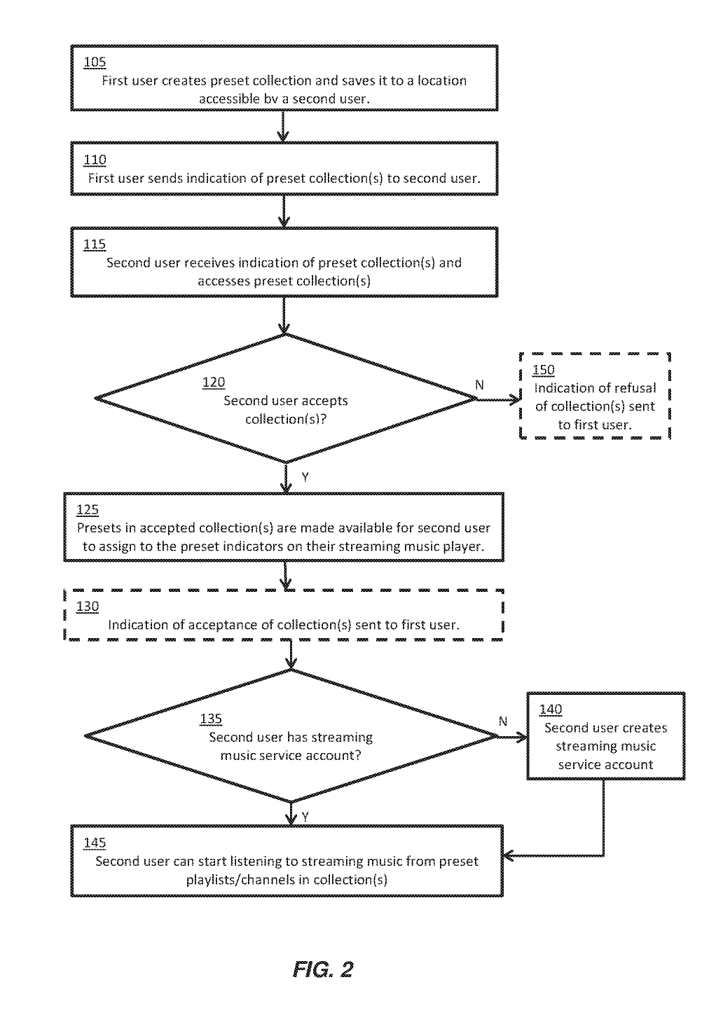

One example of a method of peer-to-peer sharing of preset collections is illustrated in the flowchart of FIG. 2. In act 105 of the method, a first user creates a preset collection by selecting a set of preset channels or playlists and saving the set as a collection on their streaming music player, streaming music player controller (e.g., a smart phone programmed with an app for controlling the streaming music player), or in an on-line database or user account associated with the user's streaming music player. The first user may store the collection at an on-line location that is accessible by a second user.

The on-line location where the second user can access the preset collection(s) may be, for example, a server running a preset collection management application. The preset collection management application may include a user interface accessible through the first user's (or any other user's) streaming music player or streaming music player controller, through the website of a retailer of the streaming music player, or through a web browser on a personal computer, laptop, or mobile computing device. The first user may enter a list of playlists and/or channels in a collection into the user interface of the preset collection management application and may enter a name for the preset collection. The list of playlists and/or channels may include, for example, a list of on-line addresses that may be used to access the list of playlists and/or channels. In some implementations, the first user must log into the preset collection management application with a unique user ID. The preset collection management application may associate the name or user ID of the first user with preset collections uploaded to or created in the preset collection management application by the first user. The preset collection management application may provide for the first user to access the first user's previously saved preset collections and modify the presets in the previously saved preset collections.

The preset collection management application may include search tools to allow other users to search for preset collections of the first user (or any other user that uploaded or created a preset collection in the preset collection management application). For example, the preset collection management application may have an interface with a search engine that a user may enter in keywords to search for a particular preset collection. A user may search by, for example, music genre, subject of audio program, band, preset collection name, or username of a user that uploaded or created a preset collection in the preset collection management application.

To facilitate creation of the preset collection, the first user may utilize a collection creation app on their streaming music player or streaming music player controller or other device (for example, by accessing a collection creation website or preset collection management application through a personal computer, laptop, or other device). The collection creation app (or website) may present the user with a list of streaming music services to select from, and the user may browse preconfigured playlists, stations, or channels from one or more of the streaming music services and may select one or more of the preconfigured playlists, stations, or channels to set as presets in the collection. If the first user has an account with a streaming music service, the first user may log in to their account with the streaming music service and may browse their own playlists or favorite channels or stations, if any, as well as any preconfigured playlists, stations, or channels offered by the streaming music service and select one or more of their own playlists or favorite channels or stations and/or one or more of the preconfigured playlists, stations, or channels offered by the streaming music service to set as presets in the collection.

In some embodiments, the first user may browse a catalog of offerings (their own playlists or favorite channels or stations, if any, and/or any preconfigured playlists, stations, or channels) of the streaming music service(s) directly through a website of a retailer from which they purchased their streaming music player. The catalog of offerings of the streaming music service(s) may be presented in the website of the retailer in a manner such that the website maintains the looks and feel of the website of the retailer but provides a listing of streaming music playlists, stations, or channels obtained from the catalog of offerings of the streaming music service(s). For example, the webpage may retain one or more visibly perceptible elements associated with the retailer, for example, a logo, a color scheme, an image of the streaming music player, etc., while also presenting the listing of streaming music playlists, stations, or channels obtained from the catalog of offerings of the streaming music service(s) to the first user. In some implementations, the listing of streaming music playlists, stations, or channels may be presented without the first user having to select a particular streaming music service or even without the first user being informed of the particular streaming music service from which the listing of streaming music playlists, stations, or channels was obtained.

In act 110 the first user sends an indication of the preset collection to a second user. In some implementations, the first user may send an indication of multiple preset collections created by the first user to the second user at the same time. The first user may send the indication of the preset collection(s) through the collection creation app on their streaming music player or streaming music player controller. In other examples, the first user may send the indication of the preset collection(s) through the website of the retailer or as an e-mail over a personal computer or laptop or other device. The notification could be automatically sent at the time that the first user completes the preset collection. The indication of the preset collection(s) may include identification of the playlists and/or channels in the collection, or may be a link to an on-line location where the second user can access the preset collection(s).

In act 115, the second user receives the indication of the preset collection(s) from the second user and accesses the preset collection(s) to see what presets are included in the collection(s). The indication of the preset collection(s) sent from the first user may appear as a notification on the second user's streaming music player or streaming music player controller or may be received by the second user in an e-mail from the first user. Accessing the preset collection(s) may involve the second user viewing a list of the presets in the collection(s) on their streaming music player or streaming music player controller or may involve accessing a link to the preset collection(s) sent by the first user or logging in to the preset collection management application. In some implementations the second user can sample the collection before accepting it.

The second user decides whether or not to accept the preset collection(s) sent from the first user in act 120. If the second user accepts one or more of the preset collection(s) sent from the first user, the accepted preset collections are made available to the second user. The accepted preset collections are made available to the second user by, for example, downloading the accepted preset collections onto the second user's streaming music player or streaming music player controller or by adding the accepted preset collections to an on-line user account associated with the second user's streaming music player. A notification is optionally sent to the first user of the second user's acceptance of the collection(s) (act 130).

If the second user accepts one or more of the preset collection(s) sent from the first user, a determination is made as to whether the second user has an account with the streaming music service or services hosting the playlists or channels in the accepted collections. (Act 135.) If the second user does not have the requisite accounts, the second user may be prompted to create an account with the requisite streaming music service(s) and the second user may create the requisite accounts (act 140). In some implementations the requisite streaming music service(s) may provide the second user with a trial subscription so that if the second user does not already have an account, the second user may have time to listen to the streaming music playlists, stations, or channels in the accepted collection(s) prior to deciding whether to purchase a subscription to the associated streaming music service(s).

Once the second user has the requisite streaming music service accounts created, the second user may assign the presets in one of the accepted collections to the preset indicators of their streaming music player, for example, through the user input interface 16 on the streaming music player or through their streaming music player controller and begin listening to the playlist and/or channels of the assigned collection. (Act 145.) The second user may access a list of accepted collections (and/or collections they themselves created) through their streaming music player or through their streaming music player controller to reassign different collections to the preset indicators of their streaming music player as desired.

If in act 120, the second user does not accept the collection(s) from the first user, for example, by selecting a “decline” indicator on the indication of the preset collection(s) sent from the first user, a message is optionally sent back to the first user that the second user refused to accept their collection(s). (Act 150.)

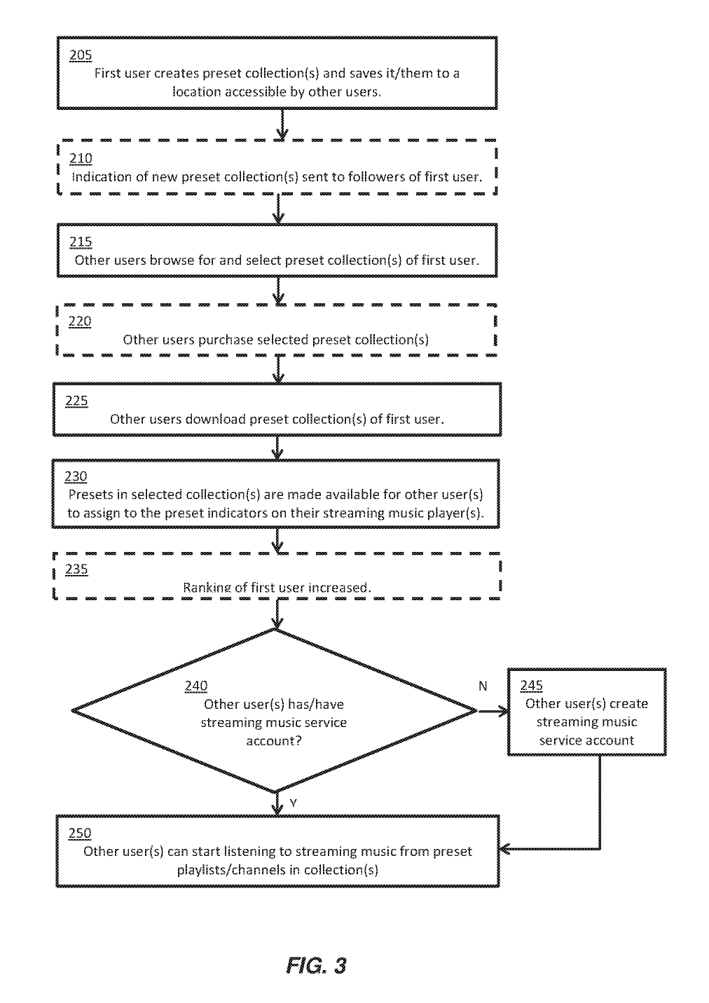

One example of a method of peer-to-many sharing of preset collections is illustrated in the flowchart of FIG. 3. In act 205 of the method, a first user creates a new preset collection by selecting a set of preset channels or playlists and saving the set as a collection on their streaming music player, streaming music player controller (e.g., a smart phone programmed with an app for controlling the streaming music player), or in an on-line database or user account associated with the user's streaming music player. The first user may store the new collection at a location that is accessible by other users. The location may be, for example, a server running a preset collection management application as described above with reference to the peer-to-peer preset collection sharing method.

To facilitate creation of the preset collection, the first user may utilize a collection creation app on their streaming music player or streaming music player controller or other device (for example, by accessing a collection creation website or preset collection management application though a personal computer, laptop, or other device). Pressing and holding a physical preset button while listening to a particular audio source may also or alternatively be used to set a preset for the particular audio source. The collection creation app (or website) may present the user with a list of streaming music services to select from, and the user may browse preconfigured playlists, stations, or channels from one or more of the streaming music services and may select one or more of the preconfigured playlists, stations, or channels to set as presets in the collection. If the first user has an account with a streaming music service, the first user may log in to their account with the streaming music service and may browse their own playlists or favorite channels or stations, if any, as well as any preconfigured playlists, stations, or channels offered by the streaming music service and select one or more of their own playlists or favorite channels or stations and/or one or more of the preconfigured playlists, stations, or channels offered by the streaming music service to set as presets in the collection.

In some embodiments, the first user may browse a catalog of offerings (their own playlists or favorite channels or stations, if any, and/or any preconfigured playlists, stations, or channels) of the streaming music service(s) directly through a website of a retailer from which they purchased their streaming music player. The catalog of offerings of the streaming music service(s) may be presented in the website of the retailer in a manner such that the website maintains the look and feel of the website of the retailer but provides a listing of streaming music playlists, stations, or channels obtained from the catalog of offerings of the streaming music service(s). For example, the webpage may retain one or more visibly perceptible elements associated with the retailer, for example, a logo, a color scheme, an image of the streaming music player, etc., while also presenting the listing of streaming music playlists, stations, or channels obtained from the catalog of offerings of the streaming music service(s) to the first user. In some implementations, the listing of streaming music playlists, stations, or channels may be presented without the first user having to select a particular streaming music service or even without the first user being informed of the particular streaming music service from which the listing of streaming music playlists, stations, or channels was obtained.

In act 210 the first user or preset collection management application through which the first user saved the newly created preset collection optionally sends an indication of the new preset collection to other users. The other users may be users who had previously indicated, for example, through the preset collection management application that they wished to be followers or fans of the first user. In some implementations, the first user or preset collection management application may send an indication of new preset collections created by the first user to the other users at the same time. In other implementations, the first user may send the indication of the new preset collection(s) through the collection creation app on their streaming music player or streaming music player controller. In other examples, the first user may send the indication of the new preset collection(s) through the website of the retailer or as an e-mail over a personal computer or laptop or other device. The indication of the new preset collection(s) may include identification of the playlists or channels in the collection(s), or may be a link to an on-line location where the other users can access the preset collection(s).

The indication of the new preset collection(s) may appear as a notification on the other users' streaming music players or streaming music player controllers or may be received by the other users in an e-mail from the first user or preset collection management application.

In act 215, the other users browse for and accesses the new preset collection(s) to see what presets are included in the new collection(s). In implementations where the other users were sent a notification of the new preset collection(s), accessing the new preset collection(s) may involve selecting a link in a message including the notification of the new preset collection(s). Accessing the new preset collection(s) may involve the other users viewing a list of the presets in the collection(s) on their streaming music players or streaming music player controllers. In an implementation in which the other users are not sent notifications of new preset collection(s) created by the first user, accessing the first user's new preset collection(s) may involve browsing the preset collection management application or other location where the first user's preset collections may be stored for the first user's preset collections. After accessing the first user's new preset collection(s), the other users may select the collection or collections that they are interested in obtaining for their streaming music system.

In some implementations, the other users may pay a fee to access the first user's preset collection(s), and thus, in optional act 220, the other users may pay a fee to the first user. The fee may be paid through the preset collection management application or through another on-line payment application, for example, PayPal®.

In act 225, the other users download the selected first user's preset collection(s) onto the other users' streaming music players or streaming music player controllers or by adding the selected first user's preset collection(s) to on-line user accounts associated with the other user's streaming music players. The downloaded preset collection(s) are then available for the other users to assign to the preset indicators on their streaming music players. (Act 230.)

In some implementations, downloading of one of the first user's preset collections causes a ranking or rating of the first user in the preset collection management application to be increased. (Act 235.) The ranking or rating of the first user may be displayed to other users in the preset collection management application when browsing preset collections of the first user. In some implementations, the preset collection management application may include a listing of most highly ranked preset collection creators and/or a listing of preset collection creators whose rankings are trending higher. These listings may assist a user in selecting a preset collection from a popular or highly ranked preset collection creator.

If another user purchases or downloads one or more of the first user's preset collection(s), a determination is made as to whether the other user has an account with the streaming music service or services hosting the playlists or channels in the purchased or downloaded collections. (Act 240.) If the other user does not have the requisite accounts, the other user may be prompted to create an account with the requisite streaming music service(s) and the other user may create the requisite accounts (act 245). In some implementations the requisite streaming music service(s) may provide the other user with a trial subscription so that if the other user does not already have an account, the other user may have time to listen to the streaming music playlists, stations, or channels in the downloaded collection(s) prior to deciding whether to purchase a subscription to the associated streaming music service(s).

Once the other user has the requisite streaming music service accounts created, the other user may assign the presets in the downloaded collection to the preset indicators of their streaming music player, for example, through the user input interface 16 on the streaming music player or through their streaming music player controller and begin listening to the playlist and/or channels of the downloaded collection. (Act 250.) The other user may access a list of downloaded collections (and/or collections they themselves created) through their streaming music player or through their streaming music player controller to reassign different collections to the preset indicators of their streaming music player as desired.

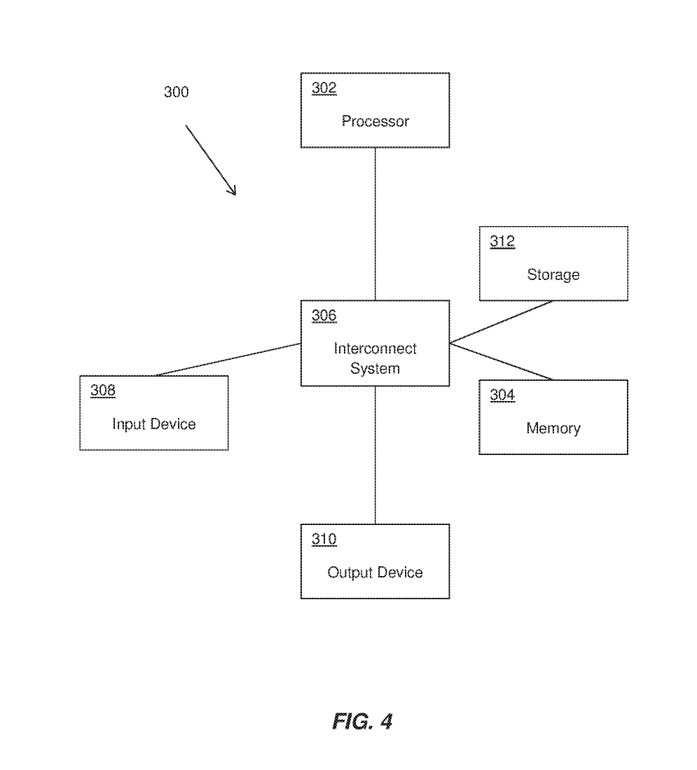

The various computer systems disclosed herein, for example, a computer system hosting the preset collection management application or the streaming music controller 50 may include specialized software executing in a general-purpose computer system 300 such as that shown in FIG. 4. The computer system 300 may include a processor 302 connected to one or more memory devices 304, such as a disk drive, solid state memory, or other non-transitory recording medium for storing data.

Memory 304 is typically used for storing programs and data during operation of the computer system 300. Components of computer system 300 may be coupled by an interconnection mechanism 306, which may include one or more busses (e.g., between components that are integrated within a same machine) and/or a network (e.g., between components that reside on separate discrete machines). The interconnection mechanism 306 enables communications (e.g., data, instructions) to be exchanged between system components of system 300. Computer system 300 also includes one or more input devices 308, for example, a keyboard, mouse, trackball, microphone, touch screen, and one or more output devices 310, for example, a printing device, display screen, and/or speaker.

The computer system may include specially-programmed, special-purpose hardware, for example, an application-specific integrated circuit (ASIC). Aspects and embodiments disclosed herein may be implemented in software, hardware or firmware, or any combination thereof. Further, such methods, acts, systems, system elements and components thereof may be implemented as part of the computer system described above or as an independent component.

Although computer system 300 is shown by way of example as one type of computer system upon which various aspects and embodiments disclosed herein may be practiced, it should be appreciated that aspects and implementations disclosed herein are not limited to being implemented on the computer system as shown in FIG. 4. Various aspects and implementations disclosed herein may be practiced on one or more computers having a different architecture or components than shown in FIG. 4.

Computer system 300 may be a general-purpose computer system that is programmable using a high-level computer programming language. Computer system 300 may be also implemented using specially programmed, special purpose hardware. In computer system 300, processor 302 is typically a commercially available processor such as the well-known Pentium™ or Core™ class processors available from the Intel Corporation. Many other processors are available, including programmable logic controllers. Such a processor usually executes an operating system which may be, for example, the Windows 7, Windows 8, or Windows 10 operating system available from the Microsoft Corporation, the MAC OS System X available from Apple Computer, the Solaris Operating System available from Sun Microsystems, or UNIX available from various sources. Many other operating systems may be used.

One or more portions of the computer system may be distributed across one or more computer systems (not shown) coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects and embodiments disclosed herein may be performed on a client-server system that includes components distributed among one or more server systems that perform various functions according to various aspects and embodiments disclosed herein. These components may be executable, intermediate (e.g., IL) or interpreted (e.g., Java) code which communicate over a communication network (e.g., the Internet) using a communication protocol (e.g., TCP/IP). In some embodiments one or more components of the computer system 300 may communicate with one or more other components over a wireless network, including, for example, a cellular telephone network.

It should be appreciated that the aspects and implementations disclosed herein are not limited to executing on any particular system or group of systems. Also, it should be appreciated that the aspects and implementations disclosed herein are not limited to any particular distributed architecture, network, or communication protocol. Various aspects and implementations disclosed herein are may be programmed using an object-oriented programming language, such as SmallTalk, Java, C++, Ada, or C# (C-Sharp). Other object-oriented programming languages may also be used. Alternatively, functional, scripting, and/or logical programming languages may be used, for example, ladder logic. Various aspects and implementations disclosed herein may be implemented in a non-programmed environment (e.g., documents created in HTML, XML or other format that, when viewed in a window of a browser program, render aspects of a graphical-user interface (GUI) or perform other functions). Various aspects and implementations s disclosed herein may be implemented as programmed or non-programmed elements, or any combination thereof.

Having thus described several aspects of at least one implementation, it is to be appreciated various alterations, modifications, and improvements will readily occur to those skilled in the art. Such alterations, modifications, and improvements are intended to be part of this disclosure, and are intended to be within the spirit and scope of the disclosure. The acts of methods disclosed herein may be performed in alternate orders than illustrated, and one or more acts may be omitted, substituted, or added. One or more features of any one example disclosed herein may be combined with or substituted for one or more features of any other example disclosed. Accordingly, the foregoing description and drawings are by way of example only.

The phraseology and terminology used herein is for the purpose of description and should not be regarded as limiting. As used herein, the term “plurality” refers to two or more items or components. As used herein, dimensions which are described as being “substantially similar” should be considered to be within about 25% of one another. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A computer system comprising a processor and a non-transitory computer readable memory including instructions that when executed by the processor cause the computer system to:
receive a definition of a preset collection including a plurality of presets for a streaming music player from a first user;
present a second user with an indication of the preset collection;
receive an indication of a selection by the second user of the preset collection; and
send instructions to assign the plurality of presets to preset indicators of a streaming music player of the second user responsive to receiving the indication of the selection from the second user.

2. The system of claim 1, wherein the instructions, when executed by the processor, further cause the computer system to notify the first user of a refusal of acceptance of the preset collection from the second user responsive to receiving an indication of refusal of acceptance of the preset collection from the second user.

3. The system of claim 1, wherein the instructions, when executed by the processor, further cause the computer system to:
execute software configured to control or otherwise interact with a device other than the streaming music player of the second user or a controller of the streaming music player of the second user; and
associate the software with one of the preset indicators of the streaming music player of the second user, selection of the one of the preset indicators causing the software to be executed by the one of the streaming music player of the second user, the controller of the streaming music player of the second user or other device.

4. The system of claim 3, wherein the software, when executed by the one of the streaming music player of the second user or the controller of the streaming music player causes one or more of audio rendered through the streaming music player of the second user to be synchronized with a video presentation of a video display device of the second user or lighting in a home of the second user to be adjusted.

5. The system of claim 1, wherein the instructions, when executed by the processor, further cause the computer system to:
present a search tool configured to search for a preset collection in a memory of the computer system to a user;
receive a search query from the user in the search tool; and
present a list of one or more preset collections matching the search criteria to the user.

6. The system of claim 1, wherein the instructions, when executed by the processor, further cause the computer system to send an indication of the preset collection to one or more of the second user's streaming music player, a controller of the second user's streaming music player, or an online account associated with the second user's streaming music player.

7. The system of claim 1, wherein the instructions, when executed by the processor, further cause the computer system to:
present a plurality of users with the indication of the preset collection;
receive indications of selections of the preset collection by the plurality of users; and
send instructions to assign the plurality of presets to preset indicators of streaming music players or controllers of said music players of the plurality of users responsive to the receipt of the indications of the selections from the plurality of users.

8. The system of claim 7, wherein the instructions, when executed by the processor, further cause the computer system to increase a popularity ranking of the first user responsive to receiving an indication of a selection of the preset collection by one of the plurality of users.

9. The system of claim 7, wherein the instructions, when executed by the processor, further cause the computer system to present the plurality of users with the indication of the preset collection responsive to the first user defining the preset collection in the system.

10. The system of claim 1, wherein the instructions, when executed by the processor, further cause the computer system to present the first user with a list of streaming audio channels to select from to include as presets in the preset collection by:
identifying a source of streaming audio channels; and
presenting a list of streaming audio channels in a composite web page having a look and feel of a host web page of a retailer associated with the streaming music player.

11. The system of claim 10, wherein the instructions, when executed by the processor, further cause the computer system to associate a user ID of the first user with the preset collection.

12. A method comprising:
receiving, at a computer system, a definition of a preset collection including a plurality of presets for a streaming music player from a first user;
sending a second user an indication of the preset collection;
receiving, at the computer system, an indication of a selection by the second user of the preset collection; and
sending instructions to assign the plurality of presets to preset indicators of a streaming music player of the second user responsive to receiving the indication of the selection.

13. The method of claim 12, further comprising:
receiving, at the computer system, an indication of a refusal of acceptance of the preset collection from the second user; and
notifying the first user of the refusal of acceptance.

14. The method of claim 12, further comprising:
sending instructions configured to control a device other than the streaming music player of the second user to one of the streaming music player of the second user or a controller of the streaming music player of the second user;
associating the instructions with one of the preset indicators of the streaming music player of the second user; and
executing the instructions by the one of the streaming music player of the second user or the controller of the streaming music player of the second user responsive to selection of the one of the preset indicators.

15. The method of claim 12, further comprising:
presenting a search tool configured to search for a preset collection in a memory of the computer system to a user;
receiving a search query from the user in the search tool; and
presenting a list of one or more preset collections matching the search criteria to the user.

16. The method of claim 12, further comprising downloading the definition of the preset collection to one or more of the second user's streaming music player, a controller of the second user's streaming music player, or an online account associated with the second user's streaming music player.

17. The method of claim 12, further comprising:
presenting a plurality of users with an indication of the preset collection;
receiving indications of selections of the preset collection by the plurality of users; and
assigning the plurality of presets to preset indicators of streaming music players of the plurality of users responsive to receiving the indications of the selections from the plurality of users.

18. The method of claim 12, further comprising increasing a popularity ranking of the first user responsive to receiving an indication of a selection of the preset collection by one of the plurality of users.

19. The method of claim 12, further comprising presenting the plurality of users with the indication of the preset collection responsive to the first user defining the preset collection in the system.

20. A streaming music player comprising:
a processor;
a network interface operatively coupled to the processor and configured to access streaming audio content from one or more streaming audio content sources;
an electro-acoustic transducer operatively coupled to the processor;
a plurality of preset indicators operatively coupled to the processor, each of the plurality of preset indicators configured to initiate streaming and rendering of content from an assigned audio channel from one of the streaming audio content sources through the electro-acoustic transducer; and
a memory operatively coupled to the processor, the memory including programming which when executed by the processor causes the processor to access a cloud-based database including account information associated with the streaming music player including a set of collections of audio channel presets associated with a unique identifier of the streaming music player and to assign one of the collections of audio channel presets to the plurality of preset indicators.

21. The streaming music player of claim 20, configured to execute instructions that control operation of a device other than the streaming music player responsive to selection of a preset indicator associated with the instructions.
